(19) United States
(12) Patent Application Publication
(10) Pub. No.: US 2022/0082814 A1
(43) Pub. Date: Mar. 17, 2022

(54) REMOTE EXCHANGEABLE FILTER SYSTEM

(71) Applicants: Adam Kielczewski, San Diego, CA (US); Amir Sharomi, San Diego, CA (US)

(72) Inventors: Adam Kielczewski, San Diego, CA (US); Amir Sharomi, San Diego, CA (US)

(21) Appl. No.: 17/475,101

(22) Filed: Sep. 14, 2021

Related U.S. Application Data
(60) Provisional application No. 63/078,107, filed on Sep. 14, 2020.

(51) Int. Cl. G02B 26/00; G03B 11/00; G02B 7/00

(52) U.S. Cl. CPC G02B 26/007; G02B 7/006; G03B 11/00

(57) ABSTRACT

Disclosed herein is a remote exchangeable filter system that may include multiple lenses/filters. Further, the adjustable filter system may include a frame which may be configured to movably support the multiple lenses/filters. Further, the adjustable filter system may include an actuating mechanism operably coupled to the frame. Further, the actuating mechanism may be configured to selectively move a filter of the multiple lenses/filters into alignment with a field of view of a camera based on an actuator control command. Further, the camera may be configured for generating digital image data based on optical energy. Further, the adjustable filter system may include a power interface which may be configured to receive electrical energy from an energy source. Further, the adjustable filter system may include a communication interface electrically coupled to the actuating mechanism. Further, the communication interface may be configured to receive the actuator control command from an external device.

The current application claims a priority to the U.S. Provisional Patent application Ser. No. 63/078,107 filed on Sep. 14, 2021.

### FIELD OF THE INVENTION

Generally, the present disclosure relates to a filter system. More specifically, the present disclosure relates to remote exchangeable filter system.

### BACKGROUND OF THE INVENTION

Many photographers enjoy applying various filter lenses to cameras to achieve a desired style of photograph. Alternatively, various lenses are required to achieve a desired focal length or style for a photograph, which may be necessary to change throughout a camera's use. Additionally, many such photographers utilize drone technology to achieve high elevation photographs from otherwise unobtainable angles or locations. However, changing a lens or lens filter on a drone camera, or otherwise remotely positioned camera, requires the user to manually access the remote location. As such, in the case of drones, the drone must be flown back to the photographer, allowing the user to access the camera lens or lens filter. Alternatively, with otherwise remote cameras, such as those on elevated platforms, poles, or fastened to vehicles, the camera is difficult to reach, often forcing a photographer to climb or maneuver in dangerous locations. As a result, the photographer may miss the opportunity to take a desired photograph while swapping lenses or lens filters. Therefore, a device that allows a user to remotely change the lens or filter in a camera system is desired.

Therefore, there is a need for improved apparatuses for facilitating changing a lens or lens filter of cameras that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a remote exchangeable filter system. Further, the remote exchangeable filter system may include a plurality of lens filters. Further, the remote exchangeable filter system may include a frame which may be configured to movably support the plurality of lens filters. Further, the remote exchangeable filter system may include an actuating mechanism operably coupled to the frame. Further, the actuating mechanism may be configured to selectively move at least one filter of the plurality of lens filters into alignment with a field of view of a camera based on an actuator control command. Further, the camera may be configured for generating digital image data based on optical energy. Further, the remote exchangeable filter system may include a power interface electrically coupled to the actuating mechanism. Further, the power interface may be configured to receive electrical energy from an energy source. Further, the remote exchangeable filter system may include a communication interface electrically coupled to the actuating mechanism. Further, the communication interface may be configured to receive the actuator control command from an external device.

Further disclosed herein is a remote exchangeable filter system according to some other embodiments. Further, the remote exchangeable filter system may include a plurality of lens filters. Further, the remote exchangeable filter system may include a frame which may be configured to movably support the plurality of lens filters. Further, the remote exchangeable filter system may include an actuating mechanism operably coupled to the frame. Further, the actuating mechanism may be configured to selectively move at least one filter of the plurality of lens filters into alignment with a field of view of a camera based on an actuator control command. Further, the camera may be configured for generating digital image data based on optical energy. Further, the remote exchangeable filter system may include an energy source which may be configured to provide electrical energy to power the actuating mechanism. Further, the remote exchangeable filter system may include a wireless communication interface communicatively coupled to the actuating mechanism. Further, the wireless communication interface may be configured to wirelessly receive the actuator control command from a mobile device.

Further disclosed herein is a remote exchangeable filter system in accordance with yet other embodiments. Further, the remote exchangeable filter system may include a plurality of lens filters. Further, the remote exchangeable filter system may include a frame which may be configured to movably support the plurality of lens filters. Further, the remote exchangeable filter system may include an actuating mechanism operably coupled to the frame. Further, the actuating mechanism may be configured to selectively move at least one filter of the plurality of lens filters into alignment with a field of view of a camera based on an actuator control command. Further, the camera may be configured for generating digital image data based on optical energy. Further, the remote exchangeable filter system may include a power interface electrically coupled to the actuating mechanism. Further, the power interface may be configured to receive electrical energy from an energy source included in the camera. Further, the remote exchangeable filter system may include a wireless communication interface communicatively coupled to the actuating mechanism. Further, the wireless communication interface may be configured to wirelessly receive the actuator control command from mobile device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a perspective view of a remote exchangeable filter system, in accordance with some embodiments.

FIG. 2 is a perspective view of a remote exchangeable filter system with remotely adjustable objects like lenses or lens filters, in accordance with some embodiments.

FIG. 3 is a perspective view of a remote exchangeable filter system with a linear track and remotely adjustable objects like lenses or lens filters, in accordance with some embodiments.

FIG. 4 is a perspective view of a remote exchangeable filter system comprising an adjustable filter system and remotely adjustable objects like lenses or lens filters, in accordance with some embodiments.

FIG. 5 is a perspective view of a remote exchangeable filter system comprising a spool system with remotely adjustable lenses/lens filters, in accordance with some embodiments.

FIG. 6 is a perspective view of a remote exchangeable filter system comprising a rotating wheel system with remotely adjustable lenses/lens filters in accordance with some embodiments.

FIG. 7 is a side view of a remote exchangeable filter system, in accordance with some embodiments.

FIG. 8 is a front view of a remote exchangeable filter system of FIG. 7.

FIG. 9 is a block diagram of a remote controller to operate a remote exchangeable filter system, in accordance with some embodiments.

FIG. 10 is a perspective view of a remote exchangeable filter system, in accordance with some embodiments.

FIG. 11 is a perspective view of a remote exchangeable filter system, in accordance with some embodiments.

FIG. 12 is an illustration of an online platform consistent with various embodiments of the present disclosure.

FIG. 13 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a remote exchangeable filter system, embodiments of the present disclosure are not limited to use only in this context.

### Overview

The present disclosure relates to a camera system with remotely adjustable objects. The system has the ability to change an object that is either integrated into a housing with an existing camera or configured to be secured to an exterior of an existing housing via one or more fasteners. The adjustable system is configured to selectively move a particular object, including lens filters, in front of the camera lens. In one embodiment, the device includes lenses or lens filters that slide left to right via a spindle actuation. In another embodiment, the lenses or lens filters are on a rotating filter wheel. In yet another embodiment, the lenses or lens filters are aligned in front of the camera lens and each can be pivoted out of the viewing path. The system is operably connected to a wirelessly powered actuator which can be used to select a particular object remotely via a smartphone or another remote device. The device allows users to remotely change a lens or lens filter while operating a camera.

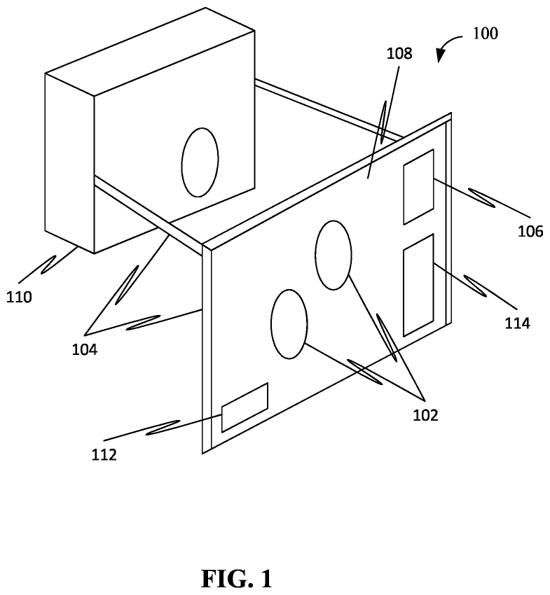

FIG. 1 is a perspective view of an adjustable filter system 100, in accordance with some embodiments. The adjustable filter system 100 may include a plurality of lens filters 102. Further, the adjustable filter system 100 may include a frame 104 which may be configured to movably support the plurality of lens filters 102.

Further, the adjustable filter system 100 may include an actuating mechanism 106 operably coupled to the frame 104. Further, the actuating mechanism 106 may be configured to selectively move at least one filter of the plurality of lens filters 102 into alignment with a field of view 108 of a camera 110 based on an actuator control command. Further, the camera 110 may be configured for generating digital image data based on optical energy.

Further, the adjustable filter system 100 may include a power interface 112 electrically coupled to the actuating mechanism 106. Further, the power interface 112 may be configured to receive electrical energy from an energy source.

Further, the adjustable filter system 100 may include a communication interface 114 electrically coupled to the actuating mechanism 106. Further, the communication interface 114 may be configured to receive the actuator control command from an external device.

Further, in some embodiments, the adjustable filter system 100 may be integrated in the camera 110.

Further, in some embodiments, the adjustable filter system 100 may include at least one fastener (not shown) which may be configured to secure the adjustable filter system 100 to a housing of the camera 110.

In some embodiments, the camera 110 may include at least one of a drone camera, a stationary elevated camera, a vehicle mounted camera and a gimbal mounted camera.

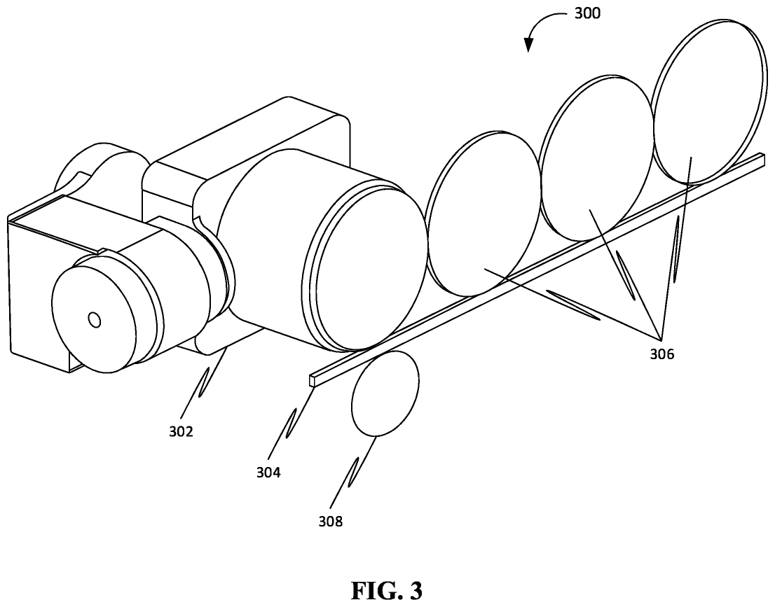

In some embodiments, the frame 104 may include a linear track. Further, the plurality of lens filters 102 may be disposed along the linear track. Further, the actuating mechanism 106 may be configured to selectively move the at least one filter along the linear track. This embodiment has been explained in detail in conjunction with FIG. 3 below.

In some embodiments, the actuating mechanism 106 may include a motor.

In some embodiments, the adjustable filter system 100 may include the energy source.

In some embodiments, the communication interface 114 may include at least one of a wired communication interface and a wireless communication interface.

In some embodiments, the communication interface 114 may include a wireless communication interface. Further, the external device may be a portable electronic device.

In some embodiments, the communication interface 114 may be electrically coupled to the camera 110. Further, the communication interface 114 may be configured to receive at least one camera control command. Further, the camera 110 may be configured to operate based on the camera control command.

In some embodiments, a filter of the plurality of lens filters 102 may include a lens filter which may be configured to alter an optical characteristic of optical energy passing through the lens filter and into the field of view 108 of the camera 110.

In some embodiments, the camera 110 may include a fixed lens which may be configured to converge the optical energy incident through the field of view 108 and onto an image sensor included in the camera 110. Further, a lens of the plurality of lens filters 102 may be configured to alter an effective focal length associated with the camera 110 based on a fixed focal length of the fixed lens and a variable focal length of the lens.

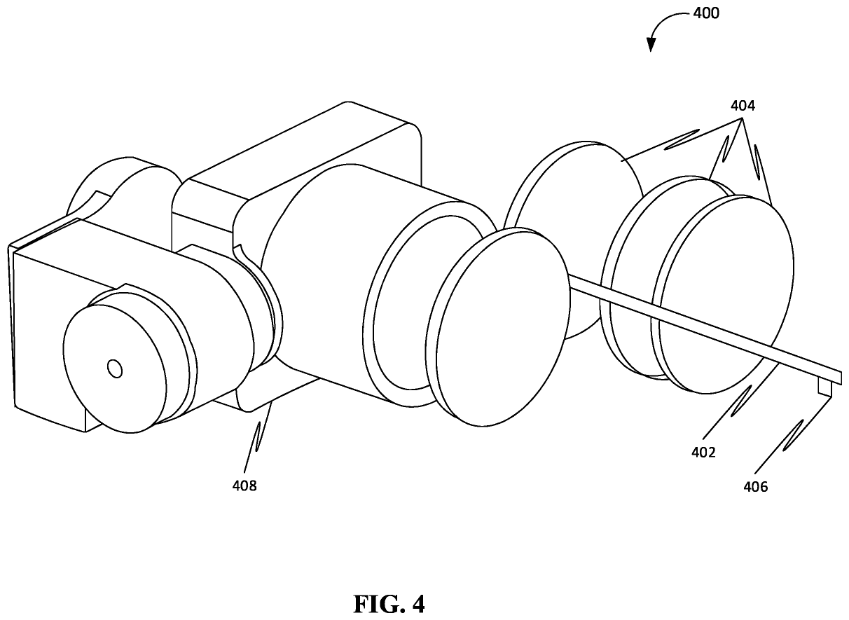

In some embodiments, the plurality of lens filters 102 may be pivotally mounted around an axis of the frame 104. Further, each filter of the plurality of lens filters 102 may be configured to be pivoted out of a viewing path of the camera 110 upon actuation by the actuating mechanism 106. This embodiment has been explained in detail in conjunction with FIG. 4 below.

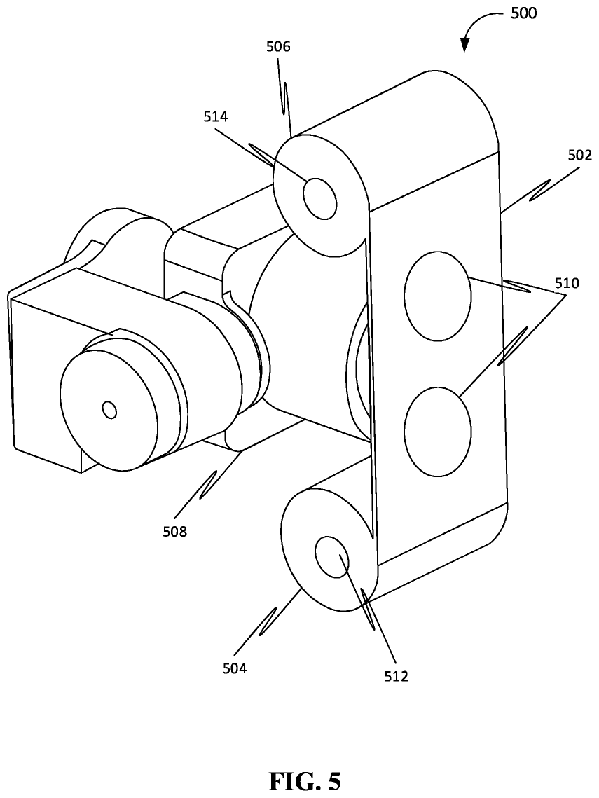

Further, in some embodiments, the frame 104 may include a pair of spools disposed on opposing lateral sides of the camera 110. Further, the frame 104 may include a flexible material disposed around the pair of spools. Further, the plurality of lens filters 102 may be attached to the flexible material along a length of the flexible material. Further, each of the plurality of lens filters 102 may be selectively movable into an aligned position relative to the camera 110 based on a rotatory movement of at least one spool of the pair of spools. Further, the actuating mechanism 106 may include a motor. This embodiment has been explained in detail in conjunction with FIG. 5 below.

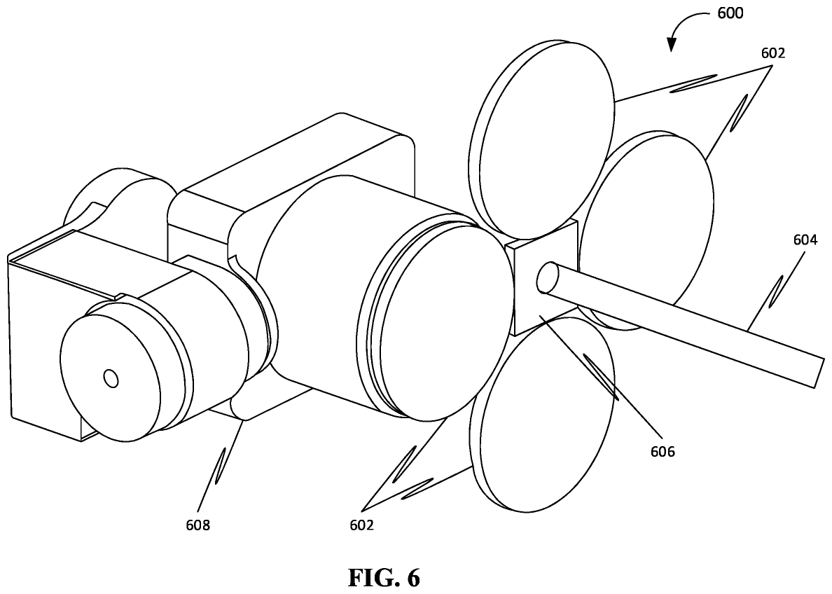

In some embodiments, the frame 104 may include a rotating wheel. Further, the plurality of lens filters 102 may be radially disposed around the rotating wheel. Further, the actuating mechanism 106 may be configured to rotate the rotating wheel to selectively position the at least one filter into a position aligned with the field of view 108 of the camera 110. This embodiment has been explained in detail in conjunction with FIG. 6 below.

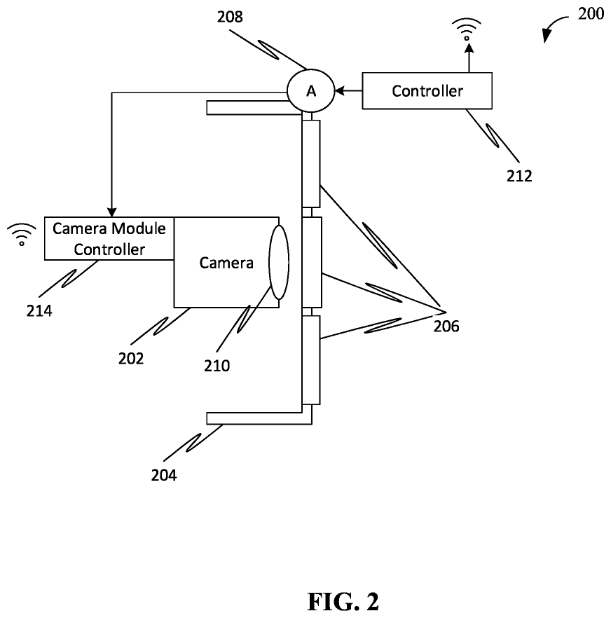

FIG. 2 is a perspective view of an adjustable filter system 200 with remotely adjustable objects like lenses, in accordance with some embodiments. The adjustable filter system 200 may be either integrated into a housing with an existing camera 202 or configured to be secured to an exterior of an existing housing via one or more fasteners. The existing camera 202 may include a variety of camera systems, such as drone cameras, stationary elevated cameras, vehicle mounted cameras, gimbal mounted cameras, and the like. Further, the adjustable filter system 200 may include a frame 204 having a plurality of lens filters or lens 206, wherein each lens 206 (of the plurality of lens filters or lens 206) can be selectively moved into alignment with the existing camera 202 via an actuating mechanism 208. Further, the actuating mechanism 208 may be configured to change the lens 206 (of the plurality of lens filters or lens 206) in front of the existing camera 202. Further, the actuating mechanism 208 can be a motor of any type of actuator that will change the position of the lens 206 (of the plurality of lens filters or lens 206) in front of a lens 210 of the existing camera 202. A filter of the plurality of lens filters or lens 206 when moved may cover the full field of view of the lens 210.

Further, in some embodiments, the adjustable filter system 200 may be operably connected to a wirelessly powered actuator which may be used to activate a particular lens or a lens filter remotely via a smartphone or similar device. Further, the adjustable filter system 200 may include a controller 212 paired a camera module controller 214 to allow a user to simultaneously control the existing camera 202 and the adjustable filter system 200. The adjustable filter system 200 allows users to remotely change a lens filter of the plurality of lens filters or lens 206 while operating the existing camera 202.

FIG. 3 is a perspective view of an adjustable filter system 300 with a linear track and remotely adjustable objects like lenses or lens filters, in accordance with some embodiments. The adjustable filter system 300 may be either integrated into a housing of an existing camera 302 or configured to be secured to an exterior of an existing housing via one or more fasteners. The adjustable filter system 300 comprises a frame 304 having a plurality of lens filters or lens 306 disposed in a linear track of the frame 304, wherein each filter of the plurality of lens filters or lens 306 may be selectively moved into alignment with the camera 302 via an actuating mechanism 308. Further, the plurality of lens filters or lens 306 are disposed along the liner track of the frame 304, such that each lens or lens filter may be selectively movable to a position aligned with the camera 302 when a motor (of the actuating mechanism 308) is actuated. The adjustable filter system 300 may be operably connected to a wirelessly powered actuator which can be used to activate a particular lens or a lens filter remotely via a smartphone or similar device. Further, the adjustable filter system 300 may include a control device to allow a user to simultaneously control the camera 302 and the adjustable filter system 300. The adjustable filter system 300 allows users to remotely change a lens or lens filter while operating a remote camera. In some embodiments, the frame 304 and the actuating mechanism 308 may include a rack and pinion arrangement.

FIG. 4 is a perspective view of an adjustable filter system 400 comprising a pivoting filter system and remotely adjustable objects like lenses or lens filters, in accordance with some embodiments. The adjustable filter system 400 includes a frame 402 comprising a plurality of lens/filters 404 and an actuating mechanism 406. In some embodiments, the plurality of lens/filters 404 is pivotally mounted around an axis of the frame 402, wherein each lens of the plurality of lens/filters 404 is configured to be pivoted out of a viewing path of the camera 408 upon actuation by the actuating mechanism 406.

Further, the filters 404 are aligned in front of the lens of the existing camera 408 and each can be pivoted out of the viewing path. Further, the plurality of lens filters or lens 404 are configured to be lowered from a storage position to the aligned position when actuated by the actuation mechanism 406, such that a desired lens or lens filter is aligned with the camera 408. The remaining lenses or lens filters are disposed outside of the field of view of the camera 408. In this way, the user can remotely select a desired camera lens filter to align with the camera 408 for taking a desired photograph.

FIG. 5 is a perspective view of an adjustable filter system 500 comprising a spool system with remotely adjustable lenses/filters, in accordance with some embodiments. The remotely adjustable lenses/filters comprise a flexible material 502 disposed about a pair of spools 504-506 on opposing lateral sides of an existing camera 508. The flexible material 502 may include a plurality of connected lenses or lens filter portions 510 along a length thereof, such that each of the plurality of lenses or lens filter portions 510 is selectively movable into an aligned position relative to the camera 508. Further, the pair of spools 504-506 are configured to simultaneously rotate when a motor (such as a motor 512 or a motor 514) is actuated, thereby feeding the lens or lens filter portions 510 between the pair of spools 504-506 and moving a desired lens filter portion into the aligned position. The pair of spools 504-506 and the flexible material 502 constitute a frame. The motors 512-514 constitute an actuating mechanism.

FIG. 6 is a perspective view of an adjustable filter system 600 comprising a rotating wheel system with remotely adjustable lenses/filters 602 in accordance with some embodiments. The adjustable lenses/filters 602 are disposed on a rotating lens wheel 604 (a frame) disposed before a camera 608. In such embodiments, an actuation mechanism 606 is configured to rotate the rotating lens wheel 604 to position a desired lens or lens filter into a position aligned with the camera 608.

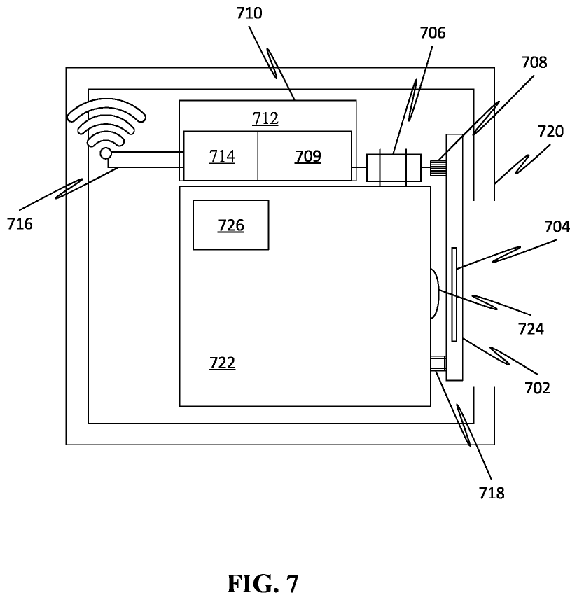

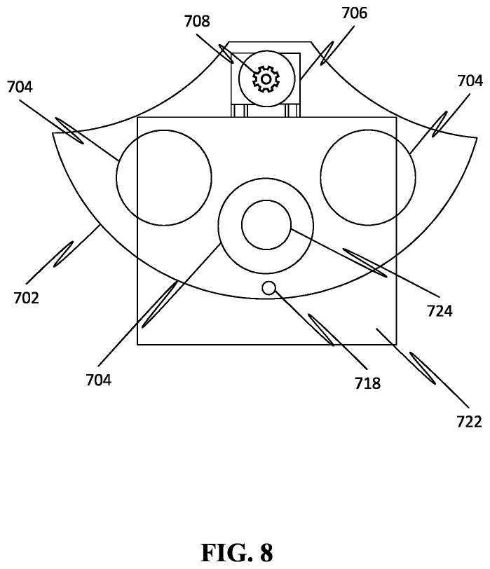

FIG. 7 is a side view of an adjustable filter system 700, in accordance with some embodiments. FIG. 8 is a front view of the adjustable filter system 700. Further, the adjustable filter system 700 may include a rotating frame 702 comprising one or more enclosed objects 704 such as lens filters or lenses.

Further, the adjustable filter system 700 may include an actuation mechanism 706 connected to the rotating frame 702 via a gear 708. The actuation mechanism 706 may include a motor with an encoder. Further, the actuation mechanism 706 may be controlled by a controller 709 of an electronic circuit 710. Further, the electronic circuit 710 may include a PCB 712 comprising the controller 709 and a receiver 714. Further, the receiver 714 may be configured to receive signals from an antenna 716. Further, the adjustable filter system 700 may include a rotating frame guider 718 which may include a ball bearing and guided track system.

Further, the adjustable filter system 700 may be placed in an enclosure 720 along with an existing camera 722. No light may get inside the enclosure 720. The camera 722 may include a Power Supply Unit (either used from camera or additional). Further, the camera 722 may include a camera lens 724.

Further, the adjustable filter system 700 may include a Power Supply Unit (PSU). In some embodiments, the adjustable filter system 700 may a PSU 726 of the camera 722.

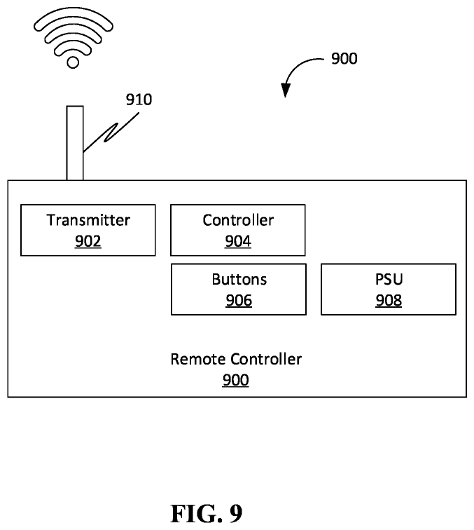

A user may send a wireless signal using a remote controller to select a lens in the one or more enclosed objects 704. The remote controller is explained in further detail in conjunction with FIG. 9 below. The antenna 716 may receive the wireless signal and send the corresponding signal to the receiver 714. Further, the receiver 714 may forward the signal to the controller 709. The controller 709 may then send control signals to the actuation mechanism 706. Thereafter, the actuation mechanism 706 may rotate the rotating frame 702 via the gear 708 in order to bring the selected lens in front of the camera lens 724.

FIG. 9 is a block diagram of a remote controller 900 to operate an adjustable filter system, in accordance with some embodiments. The remote controller 900 may include one or more of a transmitter 902, a controller 904, one or more buttons 906, a PSU 908 and an antenna 910.

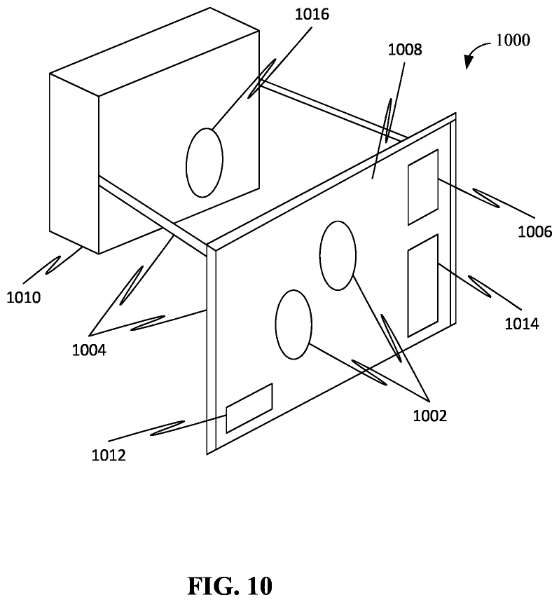

FIG. 10 is a perspective view of an adjustable filter system 1000, in accordance with some embodiments. Further, the adjustable filter system 1000 may include a plurality of lens filters 1002. Further, the adjustable filter system 1000 may include a frame 1004 which may be configured to movably support the plurality of lens filters 1002.

Further, the adjustable filter system 1000 may include an actuating mechanism 1006 operably coupled to the frame 1004. Further, the actuating mechanism 1006 may be configured to selectively move at least one filter of the plurality of lens filters 1002 into alignment with a field of view 1008 of a camera 1010 based on an actuator control command. Further, the camera 1010 may be configured for generating digital image data based on optical energy.

Further, the adjustable filter system 1000 may include an energy source 1012 which may be configured to provide electrical energy to power the actuating mechanism 1006.

Further, the adjustable filter system 1000 may include a wireless communication interface 1014 communicatively coupled to the actuating mechanism 1006. Further, the wireless communication interface 1014 may be configured to wirelessly receive the actuator control command from a mobile device.

In some embodiments, the wireless communication interface 1014 may be communicatively coupled to the camera 1010. Further, the communication interface may be configured to simultaneously receive at least one camera control command along with the actuator control command. Further, the camera 1010 may be configured to operate based on the camera control command.

In some embodiments, the camera 1010 may include a fixed lens 1016 may be configured to converge the optical energy incident through the field of view 1008 and onto an image sensor included in the camera 1010. Further, a lens of the plurality of lens filters 1002 may be configured to alter an effective focal length associated with the camera 1010 based on a fixed focal length of the fixed lens 1016 and a variable focal length of the lens.

In some embodiments, a filter of the plurality of lens filters 1002 may include a lens filter which may be configured to alter an optical characteristic of optical energy passing through the lens filter and into the field of view 1008 of the camera 1010.

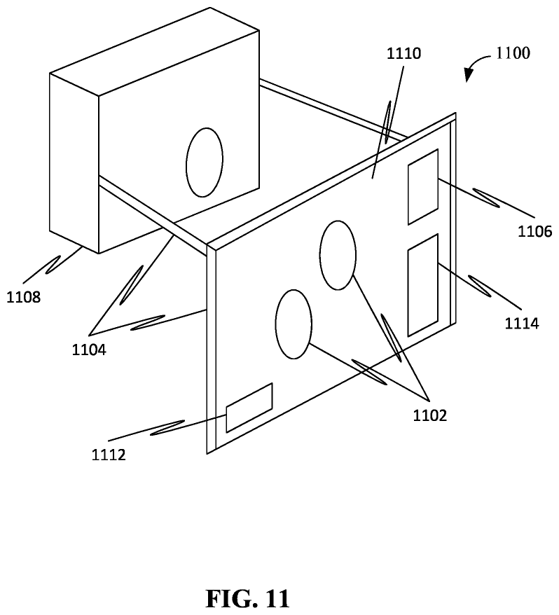

FIG. 11 is a perspective view of an adjustable filter system 1100, in accordance with some embodiments. Further, the adjustable filter system 1100 may include a plurality of lens filters 1102. Further, the adjustable filter system 1100 may include a frame 1104 which may be configured to movably support the plurality of lens filters 1102.

Further, the adjustable filter system 1100 may include an actuating mechanism 1106 operably coupled to the frame 1104. Further, the actuating mechanism 1106 may be configured to selectively move at least one filter of the plurality of lens filters 1102 into alignment with a field of view 1110 of a camera 1108 based on an actuator control command. Further, the camera 1108 may be configured for generating digital image data based on optical energy.

Further, the adjustable filter system 1100 may include a power interface 1112 electrically coupled to the actuating mechanism 1106. Further, the power interface 1112 may be configured to receive electrical energy from an energy source included in the camera 1108.

Further, the adjustable filter system 1100 may include a wireless communication interface 1114 communicatively coupled to the actuating mechanism 1106. Further, the wireless communication interface 1114 may be configured to wirelessly receive the actuator control command from mobile device.

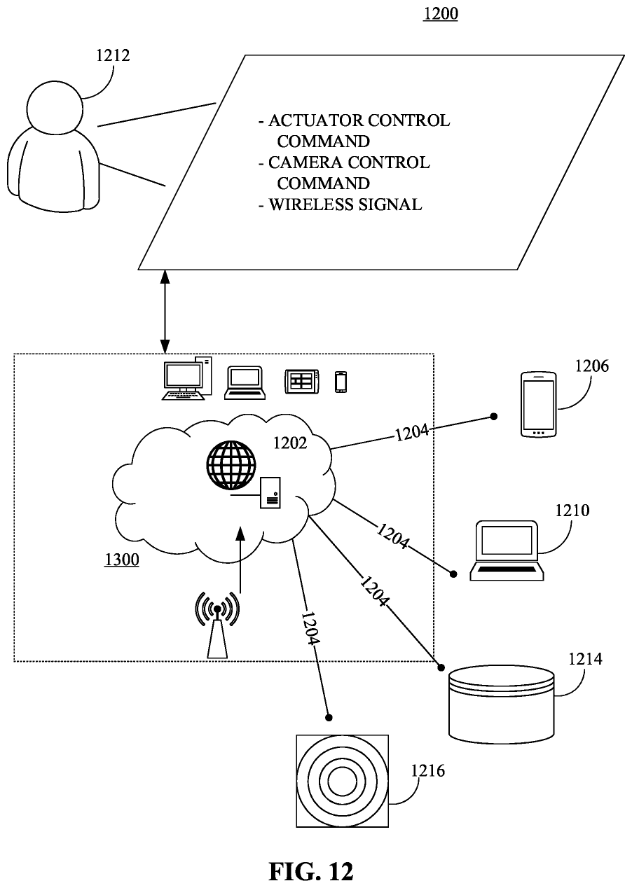

FIG. 12 is an illustration of an online platform 1200 consistent with various embodiments of the present disclosure. By way of non-limiting example, the online platform 1200 to facilitate an adjustable filter system may be hosted on a centralized server 1202, such as, for example, a cloud computing service. The centralized server 1202 may communicate with other network entities, such as, for example, a mobile device 1206 (such as a smartphone, a laptop, a tablet computer etc.), other electronic devices 1210 (such as desktop computers, server computers etc.), databases 1214, and sensors 1216 over a communication network 1204, such as, but not limited to, the Internet. Further, users of the online platform 1200 may include relevant parties such as, but not limited to, end-users, administrators, service providers, service consumers and so on. Accordingly, in some instances, electronic devices operated by the one or more relevant parties may be in communication with the platform.

A user 1212, such as the one or more relevant parties, may access online platform 100 through a web based software application or browser. The web based software application may be embodied as, for example, but not be limited to, a website, a web application, a desktop application, and a mobile application compatible with a computing device 1300.

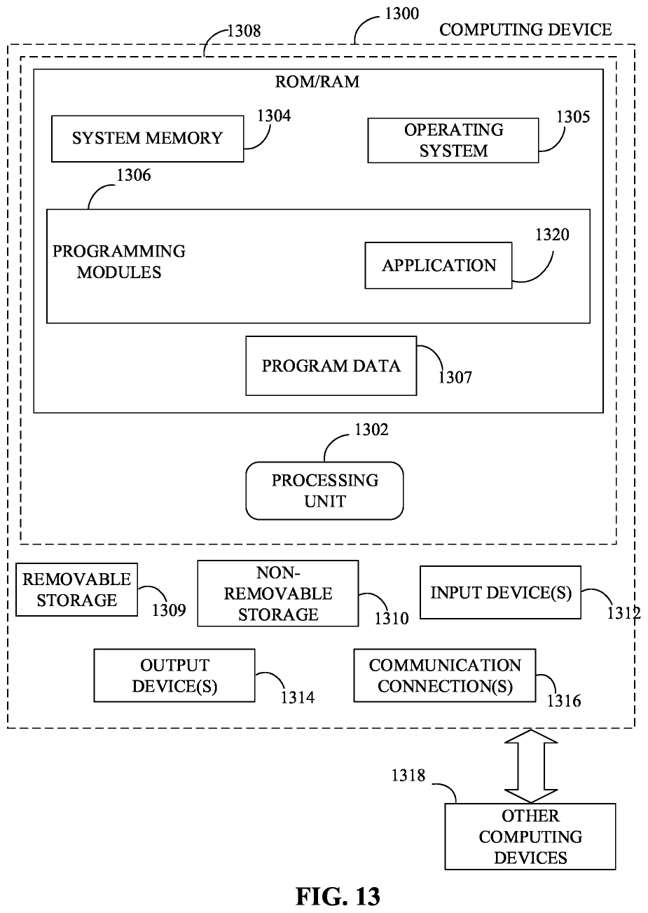

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random-access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and non-volatile, removable, and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., application 1320) may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A remote exchangeable filter system comprising:
a plurality of lens filters;
a frame configured to movably support the plurality of lens filters;
an actuating mechanism operably coupled to the frame, wherein the actuating mechanism is configured to selectively move at least one filter of the plurality of lens filters into alignment with a field of view of a camera based on an actuator control command, wherein the camera is configured for generating digital image data based on optical energy;
a power interface electrically coupled to the actuating mechanism, wherein the power interface is configured to receive electrical energy from an energy source; and
a communication interface electrically coupled to the actuating mechanism, wherein the communication interface is configured to receive the actuator control command from an external device.

2. The remote exchangeable filter system of claim 1 being integrated in the camera.

3. The remote exchangeable filter system of claim further comprising at least one fastener configured to secure the adjustable filter system to a housing of the camera.

4. The remote exchangeable filter system of claim 1, wherein the camera comprises at least one of a drone camera, a stationary elevated camera, a vehicle mounted camera and a gimbal mounted camera.

5. The remote exchangeable filter of claim 1, wherein the frame comprises a linear track, wherein the plurality of filters is disposed along the linear track, wherein the actuating mechanism is configured to selectively move the at least one filter along the linear track.

6. The remote exchangeable filter system of claim 5, wherein the actuating mechanism comprises a motor.

7. The remote exchangeable filter system of claim 1, wherein the adjustable filter system comprises the energy source.

8. The remote exchangeable filter system of claim 1, wherein the communication interface comprises at least one of a wired communication interface and a wireless communication interface.

9. The remote exchangeable filter system of claim 1, wherein the communication interface comprises a wireless communication interface, wherein the external device is a portable electronic device.

10. The remote exchangeable filter system of claim 9, wherein the communication interface is electrically coupled to the camera, wherein the communication interface is configured to receive at least one camera control command, wherein the camera is configured to operate based on the camera control command.

11. The remote exchangeable filter system of claim 1, wherein a filter of the plurality of lens filters comprises a lens filter configured to alter an optical characteristic of optical energy passing through the lens filter and into the field of view of the camera.

12. The remote exchangeable filter system of claim 1, wherein the camera comprises a fixed lens configured to converge the optical energy incident through the field of view and onto an image sensor comprised in the camera, wherein a lens of the plurality of lens filters is configured to alter an effective focal length associated with the camera based on a fixed focal length of the fixed lens and a variable focal length of the lens.

13. The remote exchangeable filter system of claim 1, wherein the plurality of lens filters is pivotally mounted around an axis of the frame, wherein each filter of the plurality of lens filters is configured to be pivoted out of a viewing path of the camera upon actuation by the actuating mechanism.

14. The remote exchangeable filter system of claim 1, wherein the frame comprises:
a pair of spools disposed on opposing lateral sides of the camera; and
a flexible material disposed around the pair of spools, wherein the plurality of lens filters is attached to the flexible material along a length of the flexible material, wherein each of the plurality of lens filters is selectively movable into an aligned position relative to the camera based on a rotatory movement of at least one spool of the pair of spools, wherein the actuating mechanism comprises a motor.

15. The remote exchangeable filter system of claim 1, wherein the frame comprises a rotating wheel, wherein the plurality of lens filters is radially disposed around the rotating wheel, wherein the actuating mechanism is configured to rotate the rotating wheel to selectively position the at least one filter into a position aligned with the field of view of the camera.

16. A remote exchangeable filter system comprising:
a plurality of lens filters;
a frame configured to movably support the plurality of lens filters;
an actuating mechanism operably coupled to the frame, wherein the actuating mechanism is configured to selectively move at least one filter of the plurality of lens filters into alignment with a field of view of a camera based on an actuator control command, wherein the camera is configured for generating digital image data based on optical energy;
an energy source configured to provide electrical energy to power the actuating mechanism; and
a wireless communication interface communicatively coupled to the actuating mechanism, wherein the wireless communication interface is configured to wirelessly receive the actuator control command from a mobile device.

17. The remote exchangeable filter system of claim 16, wherein the wireless communication interface is communicatively coupled to the camera, wherein the communication interface is configured to simultaneously receive at least one camera control command along with the actuator control command, wherein the camera is configured to operate based on the camera control command.

18. The remote exchangeable filter system of claim 16, wherein the camera comprises a fixed lens configured to converge the optical energy incident through the field of view and onto an image sensor comprised in the camera, wherein a lens of the plurality of lens filters is configured to alter an effective focal length associated with the camera based on a fixed focal length of the fixed lens and a variable focal length of the lens.

19. The remote exchangeable filter system of claim 16, wherein a filter of the plurality of lens filters comprises a lens filter configured to alter an optical characteristic of optical energy passing through the lens filter and into the field of view of the camera.

20. A remote exchangeable filter system comprising:
a plurality of lens filters;
a frame configured to movably support the plurality of lens filters;
an actuating mechanism operably coupled to the frame, wherein the actuating mechanism is configured to selectively move at least one filter of the plurality of lens filters into alignment with a field of view of a camera based on an actuator control command, wherein the camera is configured for generating digital image data based on optical energy;
a power interface electrically coupled to the actuating mechanism, wherein the power interface is configured to receive electrical energy from an energy source comprised in the camera; and
a wireless communication interface communicatively coupled to the actuating mechanism, wherein the wireless communication interface is configured to wirelessly receive the actuator control command from mobile device.
